(19) United States
(12) Patent Application Publication
(10) Pub. No.: US 2007/0004449 A1
(43) Pub. Date: Jan. 4, 2007

(54) Mobile communication device with environmental sensors

(76) Inventor: John C.K. Sham, Hong Kong (HK)

Correspondence Address: Peter S. Canelias;Law Offices of Peter S. Canelias, Suite 2148, 420 Lexington Avenue, New York, NY, 10170, US

(21) Appl. No.: 11/169,873

(22) Filed: Jun. 29, 2005

(51) Int. Cl. H04M 1/00

(52) U.S. Cl. 455/556.1

(57) ABSTRACT

The invention relates to a mobile communication device such as a cellular phone or wireless personal digital assistant (PDA) that incorporates environmental monitoring sensors to detect such factors as humidity, temperature and ultraviolet (UV) radiation levels. The invention integrates these key environmental sensors into a module that is integrated with a mobile phone or, in one embodiment, may be adapted as a separate device in wireless communication with a mobile phone or other mobile communication device. Integration is accomplished by the use of a microprocessor control unit and may employ an op-amplifier and analog-to-digital converter for certain data streams.

### BACKGROUND OF THE INVENTION

1. Field of the Invention

The invention relates to a mobile communication device such as a cellular phone or wireless personal digital assistant (PDA) that incorporates environmental monitoring sensors to detect such factors as humidity, temperature and ultraviolet (UV) radiation levels. The invention integrates these key environmental sensors into a module that is integrated with a mobile phone or, in one embodiment, may be adapted as a separate device operably engaged with a mobile phone.

2. Description of Related Art

Mobile communication devices such as PDAs and cellular phones are well known and in common use worldwide. In general, such devices now incorporate a display, such as an LCD or LED display, for displaying commands and information relating to the status and use of the device.

While the known mobile communication devices provide information useful to their varied operation, they unfortunately do not provide the user with any indication of the user's environment such as ambient temperature, the level of solar ultraviolet light exposure on the user's body, or the ambient humidity level. Thus, the device cannot inform the user whether they have exceeded a predetermined exposure level of ultraviolet radiation or provide information relating to the ambient temperature and humidity levels. The user therefore needs some indication of the degree of exposure and intensity during daylight hours to properly evaluate the physiological effect of UV exposure, as well as the convenience of real time, localized temperature and humidity readings.

It has been well established that Ultraviolet (UV) radiation emanating from the sun poses a number of health risks to humans. In addition to causing burning, aging and wrinkling of the skin, exposure to the sun has been linked to a significant increase in the occurrence rate of skin cancer and cataracts in humans. Myriad personal sun protection devices aimed at providing the user with tanning information have been developed. For instance, U.S. Pat. No. 5,365,068 to Dickerson is representative of such devices. Dickerson discloses a portable device for calculating the optimal safe sun protection factor (SPF) lotion to be applied by the user under local ambient conditions, based upon user skin type and the amount of time the user desires to spend in the sun. These devices can be beneficial for providing individual users with important information for preventing damage to the skin. However, the aforementioned personal sun protection devices have a number of limitations. Significantly, such devices do not provide users with protective information prior to being exposed to the sun. Consequently, existing devices are ineffective for providing users with real-time information for taking precautionary measures.

Ultraviolet measuring devices are known in the art. For example, U.S. Pat. No. 6,271,528 to Struye et al. discloses a reusable personal sun-monitor that provides for a personal unit that stores absorbed incident radiation in a storage phosphor panel. U.S. Pat. No. 6,484,932 to Kinney et al. shows a method and apparatus fro communicating ultraviolet radiation information via pictorial symbols. U.S. Pat. No. 6,851,814 to Chubb et al. discloses skin light exposure control methods, particularly to balance a variety of wavelengths for optimal levels of exposure.

There has been some attempt to combine these environmental features with a mobile communication device. For example, U.S. publication no. 2005/0036293 to Kohnke shows a removable housing cover for a portable radio communication device where such cover may optionally include sensors to measure humidity, temperature, air pressure, and a sunshine intensity sensor. This involves what the application describes as a Standard Entertainment Module (SEM) that in and of itself is inoperative, though it optionally includes a card reader. Also involved is a removable housing cover that has an application controller for providing phone functionality, with the interface of the removable cover consisting of features necessary for carrying out phone operations such as a microphone and earpiece, a keypad, a display and a menu and control buttons. The removable cover is attached to the SEM so that the application controller interfaces with the SEM so at to render it operative in application controller to provide standard phone functionality. The SEM and housing cover are then combined with a second supplementary attachable module with sensors to detect environmental information.

Another example is shown in U.S. publication no. 2005/0078274 to Howell et al. The application discloses tethered electrical components coupled to electrical components in or attached to a pair of eyeglasses that may include wireless communication and radiation monitoring.

### BRIEF SUMMARY OF THE INVENTION

The present invention combines the benefits of a UV meter, a humidity sensor and a temperature sensor with those of a mobile communication device having the common features of such a device. The present invention also provides a method for visually communicating specific environmental information such as UV radiation intensity levels to aid the user in preventing related health risks. The exposure measurements are based upon UV index values. The UV meter detects the intensity of ultraviolet radiation from sunlight and displays this information to the user on the mobile communication device display so that the user may gauge his or her exposure. The unit preferably has an alarm function that is visual and/or audible to alert the user when radiation levels exceed a predetermined level or UV index value.

The present invention is especially concerned with the measurement of the power of natural sunlight in circumstances where burning is likely, i.e., while walking, jogging, or engaging in other activities in which the use of a mobile communication device is desirable. In each case, power measurement is usually accomplished using a photosensor such as a photodiode. They can be adapted to measure an instantaneous power level, or integrated to give a measurement of dose. The intention of course, is to develop a device whose sensitivity spectrum accurately matches that of skin.

The device combines a mobile communication device with environmental sensors in one convenient, portable unit. In an alternate embodiment, the environmental sensor module may be operably engaged with a mobile communication device but maintained as a separate unit. The separate unit is preferably in wireless communication with the mobile communication device to perform the same tasks as the integrated embodiment.

Preferably, each embodiment unit incorporates a UV meter for measuring the UV index from 1 to 11 and higher, and transmitting the information for display or activation of an alarm; an overexposure warning (including an audible beep signal in addition to a visual display) that is adapted to alert the user when the radiation level exceeds 1 minimal erythema dose (MED).

Of the two embodiments, the integrated unit is preferred due to cost of manufacture, and its ability to utilize the power source, usually the battery, of the mobile communication device rather than incorporating a separate power source or battery for operation of the separate unit. In addition, for the wireless communication between the separate unit and the target mobile communication device, a separate communication device is necessary such as a Bluetooth enabled communication module for transmitting data from the environmental sensing unit to the target mobile communication device.

Other objects and advantages will be more fully apparent from the following disclosure and appended claims.

### BRIEF DESCRIPTION OF THE DRAWINGS

The above-mentioned and other features and objects of this invention and the manner of obtaining them will become apparent and the invention itself will be best understood by reference to the following description of an embodiment of the invention taken in conjunction with the accompanying drawings, wherein:

FIG. 1 is a block diagram of a preferred embodiment of the invention showing the integration of the environmental sensing module with the mobile communication device;

FIG. 2 is a block diagram of a preferred embodiment of the invention showing the environmental sensing module as a separate unit in communication with the mobile communication device.

### DETAILED DESCRIPTION

The combination environmental monitor and mobile communication device according to the present invention accompanies the user who wants to know the ambient environmental conditions, including temperature, humidity and the level of UV-radiation

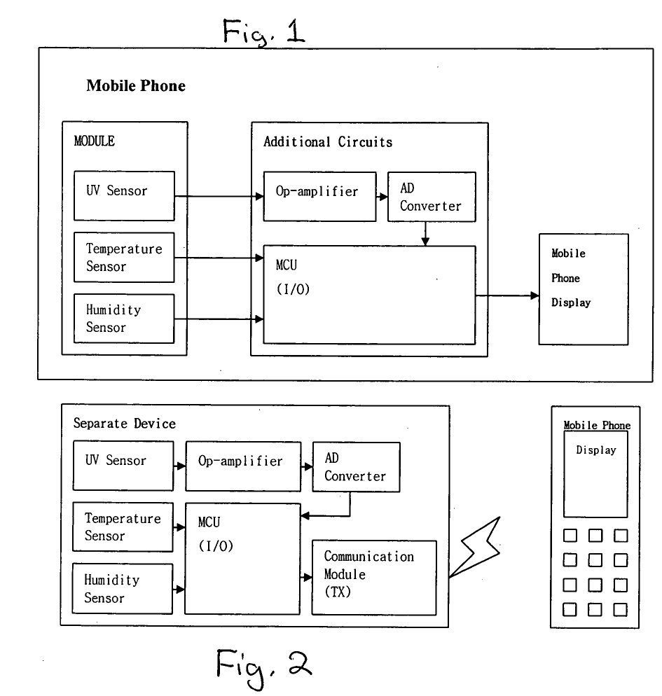

FIG. 1 shows a block diagram of the first preferred embodiment of the invention, where the environmental sensors are integrated into a mobile communication device, here a mobile phone. The sensor module shows a UV sensor, a temperature sensor, and a humidity sensor. The circuitry for integrating the functionality of the environmental sensors of the sensor module includes an operational amplifier (Op-amplifier) composed of transistors that connects to the UV sensor. Due to either the signal characteristics common to UV sensor devices or to the specific UV-related data to be conveyed, the input from the UV sensor is amplified by the Op-amplifier for output to an analog-to-digital converter (AD Converter). The AD Converter quantizes the output from the Op-amplifier and converts the output which is analog data to digital data and outputs the digital data to a microprocessor control unit (MCU) which functions as an input/output device. The MCU then outputs the data to the display of the mobile phone, usually an LCD or LED display device, but possible a TFT type display as well depending on the type of mobile communication unit.

The temperature sensor and the humidity sensor of the sensor module output directly to the MCU without the need for amplification or conversion. The MCU then outputs the data to the mobile phone display with the data derived from the UV sensor. The temperature sensor data output may be a temperature reading in Fahrenheit or Centigrade or both. The UV sensor data output may comprise an index value, preferably calculated according to standards set out below.

In the embodiment of FIG. 1, all of the components are housed within a typical mobile communication device such as a cellular phone. The invention, however, is not dependent on the form of the housing for the mobile communication device. The invention will work with open units, sometimes referred to as “brick” type phones, with PDAs, and with clamshell type housings where the upper and lower portions are hingeably attached for opening and closing the device, with the display screen ordinarily housed on the inside surface of the upper or top portion of the clamshell and with the keypad located on the inside surface of the lower or bottom portion.

In FIG. 2, an alternative embodiment of the invention is shown in block diagram form. FIG. 2 shows the same operational configuration of the sensor module and Op-amplifier and AD Converter for the UV sensor, and the MCU designed to receive input from the AD Converter for the UV sensor data and to receive input directly from the Temperature Sensor and the Humidity Sensor. However, the environmental data is outputted to a Communication Module for transmission (TX) to a mobile phone or other mobile communication device. This is due to the embodiment being a separate unit from the mobile phone, but in wireless communication with the mobile phone. This embodiment requires a separate power source such as a battery (not shown). The power source for the unit is preferably a CR2032 Lithium Battery (or 2 LR44 batteries) and may include a backup battery. Battery life is typically 1 year.

For all embodiments, the sensors, particularly the UV sensor, preferably have a glass or plastic cover to prevent contamination. The unit is preferably portable and, in that sense, is adaptable for being transported to, and implemented at, virtually any venue. The environmental sensing functions remain operative even where the mobile communication device is out of range of a radio tower, or is otherwise not receiving a transmission signal for normal wireless communication. The UV sensor preferably has an accuracy of ±10% for UV measurement. The optimal operating temperature range for the unit is between 32 and 122 degrees Fahrenheit. The optimal operational humidity level for the unit is between 0 and 95% non-condensing.

The UV sensor may output data relating to a UV index value. UV index values or value ranges are predetermined, sometimes based on the anticipated location of use, and the latitude of that anticipated location. Depending on the particular location, UV index values can vary from day-to-day, and often vary greatly over the course of a year. As an example, the variation in UV Index values over a one-year period of time. Varying index values may be obtained from the National Weather Service (NWS) or from local newspapers.

The following table shows the standards adopted by the Environmental Protection Agency (EPA). As illustrated below in Table 1, standardized exposure levels (i.e., Minimal, Low, Moderate, High, and Very High) each correlating to a defined range of generally accepted UV Index values have been established by the EPA:

TABLE 1
EPA Exposure Classifications Based Upon UV Index

| UV Index | EPA Exposure Level |
|---|---|
| 0-2 | Minimal |
| 3-4 | Low |
| 5-6 | Moderate |
| 7-9 | High |
| 10+ | Very High |

Each of the above established ranges has been correlated to time-to-burn information and specific recommended protective measures established by the National Weather Service and the Environmental Protection Agency. For example, a UV Index value of “4”, defined as “Low” level UV radiation, results in skin damage within about 15-20 minutes for a fair-skinned person, and correlates to suggested protective measures including wearing protective sunglasses, wearing a rimmed hat, and applying a protective sun screen lotion having a Sun Protection Factor (SPF) of at least 15.

Since other modifications or changes will be apparent to those skilled in the art, there have been described above the principles of this invention in connection with specific apparatus, it is to be clearly understood that this description is made only by way of example and not as a limitation to the scope of the invention.

What is claimed is:

1. An environmental sensing and communication device, comprising:
a mobile communication device having a housing;
the housing having a display;
the housing also having a sensor module, the sensor module having at least one sensor for detecting a first environmental condition;
the sensor communicating environmental condition data relating to the first environmental condition to a microprocessor control unit;
the microprocessor control unit outputting the environmental condition data to the display.

2. An environmental sensing and communication device according to claim 1, wherein the first environmental condition is selected from the group consisting of a temperature condition, a humidity condition, or a UV radiation condition.

3. An environmental sensing and communication device, comprising:
a mobile communication device having a housing;
the housing having a display;
the housing also having a sensor module, the sensor module having at least one sensor for detecting a first environmental condition;
the sensor communicating environmental condition data relating to the first environmental condition to an operational amplifier for amplification;
the operational amplifier outputting the environmental condition data to an analog-to-digital converter for converting the environmental condition data from analog to digital form;
the analog-to-digital converter outputting the environmental condition data to a microprocessor control unit;
the microprocessor control unit outputting the environmental condition data to the display.

4. An environmental sensing and communication device according to claim 3, wherein the first environmental condition is a UV radiation condition.

5. An environmental sensing and communication device according to claim 4, wherein the environmental condition data comprises a UV index value.

6. An environmental sensing and communication device, comprising:
a housing having a sensor module, the sensor module having at least one sensor for detecting a first environmental condition;
the sensor communicating environmental condition data relating to the first environmental condition to a microprocessor control unit;
the microprocessor control unit outputting the environmental condition data to a communication module for transmission to a remote mobile communication device.

7. An environmental sensing and communication device according to claim 6, wherein the first environmental condition is selected from the group consisting of a temperature condition, a humidity condition, or a UV radiation condition.

8. An environmental sensing and communication device, comprising:
a housing having a sensor module, the sensor module having at least one sensor for detecting a first environmental condition;
the sensor communicating environmental condition data relating to the first environmental condition to an operational amplifier for amplification;
the operational amplifier outputting the environmental condition data to an analog-to-digital converter for converting the environmental condition data from analog to digital form;
the analog-to-digital converter outputting the environmental condition data to a microprocessor control unit;
the microprocessor control unit outputting the environmental condition data to a communication module for transmission to a remote mobile communication device.

9. An environmental sensing and communication device according to claim 8, wherein the first environmental condition is a UV radiation condition.

10. An environmental sensing and communication device according to claim 9, wherein the environmental condition data comprises a UV index value.
